(19) United States
(12) Patent Application Publication
(10) Pub. No.: US 2007/0057780 A1
(43) Pub. Date: Mar. 15, 2007

(54) Apparatus for alerting a driver preparing to exit a motor vehicle and method thereof

(76) Inventors: Martha Bridges, Mannford, OK (US); Larry Bridges, Mannford, OK (US)

Correspondence Address: JAMES RAY & ASSOCIATES, 2640 PITCAIRN ROAD, MONROEVILLE, PA, 15146, US

(21) Appl. No.: 11/520,076

(22) Filed: Sep. 13, 2006

Related U.S. Application Data
(60) Provisional application No. 60/716,427, filed on Sep. 13, 2005.

(51) Int. Cl. B60Q 1/00

(52) U.S. Cl. 340/438

(57) ABSTRACT

An apparatus for providing an alert to a driver preparing to exit a motor vehicle includes a housing and a controller which is mounted within the housing and which is electrically coupled to at least one of a seat belt sensor, a door open sensor, a vehicle ignition system and a vehicle computer. The controller is connected to a source of electrical power and is capable of at least generating the alert in response to an exiting condition being at least one of an opened door, an unbuckled seat belt and a terminated ignition. The alert is delivered through at least one of a speaker, a buzzer, a light and a display.

### CROSS-REFERENCE TO RELATED APPLICATIONS

This application is related to and claims priority from Provisional Patent Application Ser. No. 60/716,427 filed Sep. 13, 2005.

### FIELD OF THE INVENTION

The present invention relates, in general, to alert and reminder devices for motor vehicles and, more particularly, this invention relates to an apparatus for and a method of alerting a driver preparing to exit a motor vehicle.

### BACKGROUND OF THE INVENTION

One problem that is continuously encountered by a driver preparing to exit a motor vehicle in a hurried or stressed condition is in forgetting an infant or a sleeping young child on the back seat of the vehicle. Leaving the child inside the vehicle for prolong periods of time may result in injury to or even the death of the child due to elevated temperature or dehydration.

Another problem that is continuously encountered by the driver preparing to exit the motor vehicle in a hurried or stressed condition is in forgetting personal belongings. Therefore, the driver must waste valuable time by returning to the vehicle in order to retrieve the belongings and risks being late to an important event.

Efforts have been made to eliminate the problem of forgetting the child on the back seat of the vehicle by providing child alert in combination with the car seat used by the child. U.S. Pat. No. 6,909,365 to Blake Toles, U.S. Pat. No. 6,812,844 to Burgess, U.S. Pat. No. 6,535,137 to Ryan, and U.S. Pat. No. 5,966,070 and U.S. Pat. No. 5,793,291 both to Thornton disclose various child seat alarm devices and sensors for detecting presence of the child in such child seat.

While being suitable for use in detecting presence of the child and alerting the driver of the motor vehicle, this prior art does not alleviate the problem of alerting the driver to check for personal belongings. Furthermore, the prior art identifies the need to install additional sensors within the motor vehicle and electrically connecting them to the control devices or vehicle computer. The need for using and connecting additional sensors increases cost and complexity of the installation.

Yet another problem that is continuously encountered by drivers of motor vehicles is in recording various reminder messages to themselves during driving. It is common, during driving, to identify a certain action to be performed upon exiting the motor vehicle. However, it is difficult for drivers to write down a reminder while driving. Prior to the present invention, drivers must find a convenient location to temporarily park the motor vehicle or wait for a prolong stop at a traffic light.

There is a need for an improved apparatus for and a method of alerting the driver to the presence of the child or the person in the motor vehicle and equally as well there is a need for alerting the driver to the presence of personal belongings to be collected by the driver and there is a further need for enabling the driver to record a reminder message during driving.

### SUMMARY OF THE INVENTION

According to one embodiment, the invention provides an apparatus for providing an alert to a driver preparing to exit a motor vehicle. The apparatus includes a housing and a control means which is mounted within the housing. The control means is electrically coupled to at least one of a seat belt sensor, a door open sensor, a vehicle ignition system and a vehicle computer. The control means is connected to a source of electrical power. The control means is capable of at least generating the alert in response to an exiting condition being at least one of an opened door, an unbuckled seat belt and a terminated ignition. Alert delivery means is coupled to the control means and is provided for delivering the alert to such driver.

According to another embodiment of the invention, there is provided a method of alerting a driver that is preparing to exit a motor vehicle to at least one of a presence of at least one of a child and an object and an action to be performed by the driver. The method includes the steps of providing an alert means capable of at least delivering an alert to the driver. Then, electrically coupling the alert means to at least one of a seat belt sensor, a door open sensor, a vehicle ignition system and a vehicle computer. Next, sensing, by a control means coupled to the alert means, an exiting condition being at least one of an opened door, an unbuckled seat belt, and a terminated ignition. Finally, delivering the alert in response to sensing the exiting condition.

According to yet another embodiment, the invention provides a method of alerting a driver that is preparing to exit the motor vehicle to at least one of a presence of at least one of a child and an object and an action to be performed by the driver. The method includes the steps of sensing, by way of a vehicle computer, an exiting condition being at least one of an opened door, an unbuckled seat belt and a terminated ignition and then delivering an alert to the driver upon sensing the exiting condition.

### OBJECTS OF THE INVENTION

It is, therefore, one of the primary objects of the present invention to provide an apparatus for alerting a driver preparing to exit a motor vehicle.

Another object of the present invention is to provide an apparatus for alerting a driver preparing to exit a motor vehicle which can be easily installed in vehicles presently in use.

Yet another object of the present invention is to provide an apparatus for alerting a driver preparing to exit a motor vehicle which is capable of delivering a preselected voice alert message.

A further object of the present invention is to provide an apparatus for alerting a driver preparing to exit a motor vehicle which is capable of providing a visual alert.

Yet a further object of the present invention is to provide an apparatus for alerting a driver preparing to exit a motor vehicle which enable the driver to record a predetermined alert message.

An additional object of the present invention is to provide an apparatus for alerting a driver preparing to exit a motor vehicle which is integrated into the motor vehicle.

Another object of the present invention is to provide an apparatus for alerting a driver preparing to exit a motor vehicle which doe not require use and connection of additional sensors.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a side elevation view of the apparatus of the present invention for alerting a driver preparing to exit a motor vehicle;

FIG. 2 is a front elevation view of the apparatus of FIG. 1; and

FIG. 3 is a block diagram of the apparatus of FIG. 1.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

According to a first embodiment of the invention, there is provided an apparatus, generally designated as 20, for providing an alert to a driver preparing to exit a motor vehicle 2. Such motor vehicle 2 may be a well known passenger type motor vehicle 2 which is characterized by a driver side door 3, a dashboard 4 and a driver seat belt 5.

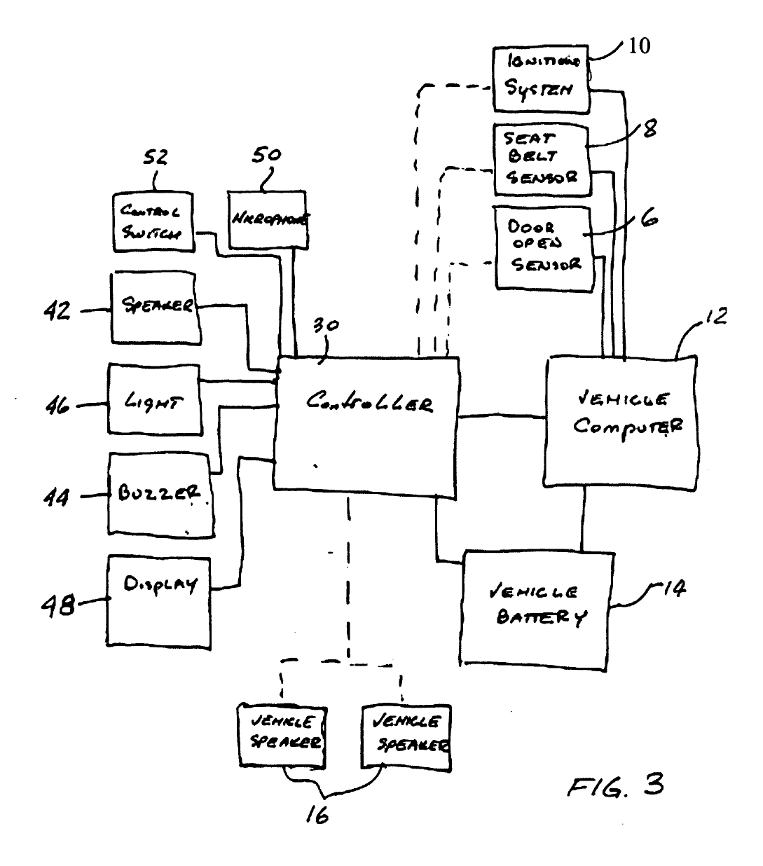

Now in reference to FIGS. 1-3, the apparatus 20 includes a housing 22 which is preferably mounted onto the dashboard 4 of such motor vehicle 2.

A control means, generally designated as 30, is mounted within the housing 22 and is electrically coupled to at least one of a door open sensor 6, seat belt sensor 8, a vehicle ignition system 10 and a vehicle computer 12. The control means 30 may be directly coupled to the door open sensor 6, the seat belt sensor 8 and the vehicle ignition system 10 or may receive signals therefrom through the vehicle computer 12. The control means 30 is connected to an electrical power source, which is preferably a battery 14 of such motor vehicle 2. Alternatively, at least one battery (not shown) may be provided within the housing 22. In operation, the control means 30 is capable of at least generating the alert in response to a condition being at least one of an opened door, an unbuckled seat belt, and a terminated ignition. Preferably, the control means 30 is a microprocessor type controller 30.

The apparatus 20 further includes means, generally designated as 40, for delivering the alert to such driver. In the presently preferred embodiment of the invention, such alert delivering means 40 is at least partially mounted within the housing 22.

According to one embodiment, the alert is at least one preselected audio message stored within the control means 30 and the alert delivering means 40 includes a speaker means 42 for broadcasting the at least one audio message. Preferably, the speaker means 42 includes a speaker 42 which is mounted within the housing 22 and which is located behind a speaker port 24 formed within a wall portion of the housing 22. In operation, such at least one audio message is preferably preselected based on the requirements of the driver of the motor vehicle 2 and is stored within the control means 30. Then, when the driver is preparing to exit the motor vehicle 2 by way of opening the side door 3, unbuckling seat belt 5 or rotating ignition key 7 to an OFF position, the exiting condition is sensed by the door open sensor 6, seat belt sensor 8, and vehicle ignition system 10 respectively and a respective signal is sent to the control means 30 either directly or by way of the vehicle computer 12. In response to a receipt of such signal, the control means 30 generates such at least one audio message for delivery through the speaker means 42.

Accordingly, if the driver of the motor vehicle 2 is a parent, guardian or a caretaker of an infant or a small child, the preselected message may alert the driver to check for presence of such small child. The message may also instruct the driver to check for presence of any belongings prior to exiting the motor vehicle 4.

Alternatively to or in combination with the speaker means 42, the present invention contemplates that the alert delivering means 40 may include a buzzer 44 for providing an audible alert, a light means 46, preferably of a flashing type, which is viewable by such driver for providing a visual type alert and a display 48 for displaying graphics and/or text messages. Any one of the well known speakers, buzzers, lights and displays may be employed in the present invention.

The present invention also contemplates that the apparatus 20 includes a microphone means 50 which is usable by at least such driver to record at least one audio message which is then stored within the control means 30 and is delivered as such alert by the alert delivery means 40 in response to the sensed exiting condition. The microphone means 50 is preferably mounted within the housing 22 and is located behind a microphone port 26 formed within the wall portion of the housing 22. Accordingly, the apparatus 20 further includes at least one manually operable control switch 52 for operating the microphone means 50.

In operation, the driver of the motor vehicle 40 is able to simply and conveniently record a message by way of operating the at least one control switch 52 and speaking into the microphone means 50. The message is then stored within the control means 30 and is delivered by the alert delivery means 40 when the driver is preparing to exit the motor vehicle 2. It will be appreciated that providing a plurality of control switches 52 will enable the driver to erase the recorded message, play back the recorded message and to re-record the message if required.

It will be understood that the apparatus 30 of the present invention is advantageous for retrofitting the motor vehicles 2 presently in service.

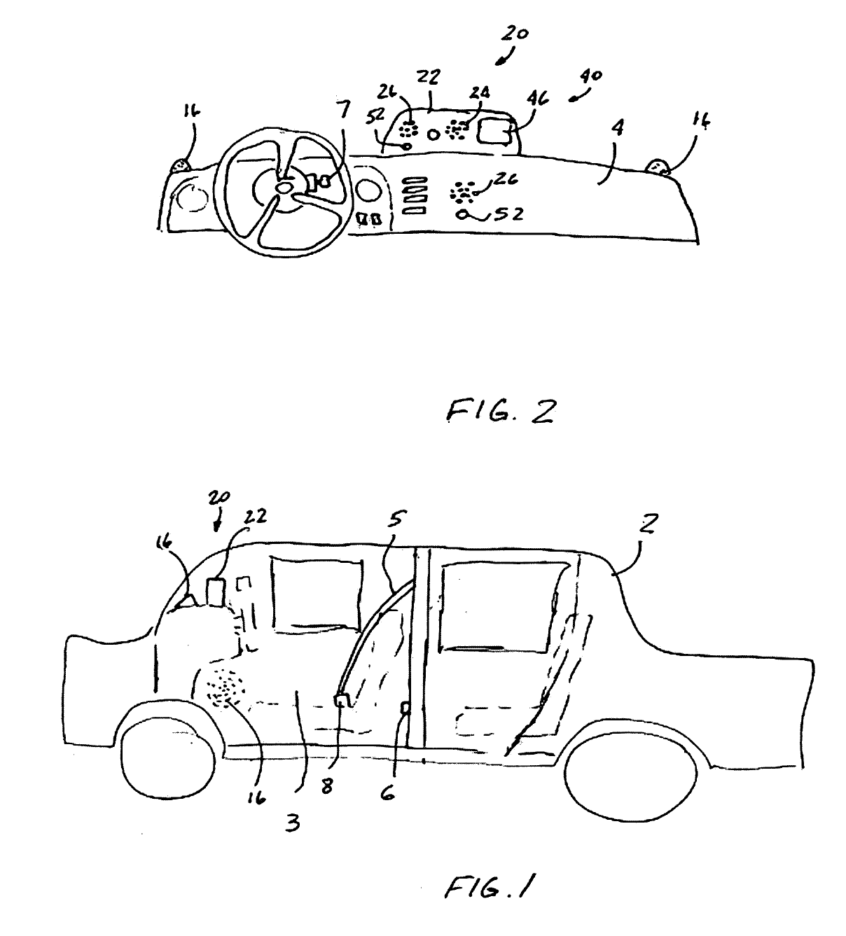

For use with a new motor vehicle 2, the apparatus 30 constructed according to the embodiments described supra may be integrated into such motor vehicle 2. For example, the apparatus 30 may by installed into the dashboard 4. Alternatively, only the microphone means 50 may be mounted within a predetermined location within such motor vehicle 2, for example, such as dashboard 4, as best shown in FIG. 2. The speaker means 42 may be any one of the plurality of speakers 16 generally provided within such motor vehicle 2. The at least one preselected message is than stored within the vehicle computer 12 which, as is generally well known, is electrically coupled to such door open sensor 6, seat belt sensor 8, and the vehicle ignition system 10. Accordingly, the computer 12 is then adapted to perform functions of the control means 30. The at least one control switch 52 may be also mounted in close proximity to the microphone means 50 or may be any one of the control switches (not shown) presently employed in the motor vehicle 2, for example to manipulate an entertainment system of such motor vehicle 2.

Although the present invention has been shown in terms of alerting the driver of the passenger-type motor vehicle 2 about the presence of the child or belongings, it will be apparent to those skilled in the art, that the present invention may be used in other applications. For example, the apparatus 20 may be installed within a bus or a transportation vehicle for alerting the driver of such vehicle about presence of a disabled person or a sleeping older adult. The apparatus 30 may be also installed in a delivery-type vehicle for providing the driver with various instructions. For example, the driver may be instructed on specific items to be delivered or collected at a particular location.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. An apparatus for providing an alert to a driver preparing to exit a motor vehicle, said apparatus comprising:
(a) a housing;
(b) a control means mounted within said housing and electrically coupled to at least one of a seat belt sensor, a door open sensor, a vehicle ignition system and a vehicle computer, said control means connected to a source of electrical power, said control means capable of at least generating said alert in response to an exiting condition being at least one of an opened door, an unbuckled seat belt and a terminated ignition; and
(c) means coupled to said control means for delivering said alert to such driver.

2. The apparatus, according to claim 1, wherein said alert includes at least one preselected audio message stored within said control means and wherein said alert delivering means is at least one speaker for broadcasting said at least one audio message.

3. The apparatus, according to claim 2, wherein said at least one speaker is mounted within said housing and is located behind a speaker port formed within a wall portion of said housing.

4. The apparatus, according to claim 2, wherein said at least one speaker is mounted within a structure of such motor vehicle.

5. The apparatus, according to claim 1, wherein said alert delivering means is a buzzer.

6. The apparatus, according to claim 1, wherein said alert delivering means is a light means viewable by such driver.

7. The apparatus, according to claim 1, wherein said alert delivering means is a display means viewable by such driver.

8. The apparatus, according to claim 1, wherein said apparatus includes a microphone means which is usable by at least such driver to communicate at least one audio message which is then stored within said control means and delivered as such alert in response to said exiting condition.

9. The apparatus, according to claim 8, wherein said microphone means is mounted within said housing and is located behind a microphone port formed within a wall portion of said housing.

10. The apparatus, according to claim 8, wherein said microphone means is mounted within a dashboard of such motor vehicle.

11. The apparatus, according to claim 8, wherein said apparatus further includes at least one manually operable control switch for operating said microphone means.

12. A method of alerting a driver that is preparing to exit a motor vehicle to at least one of a presence of at least one of a child and an object and an action to be performed by said driver, said method comprising the steps of:
(a) providing an alert means capable of at least delivering an alert to said driver;
(b) electrically coupling said alert means to at least one of a seat belt sensor, a door open sensor, a vehicle ignition system and a vehicle computer;
(c) sensing, by a control means coupled to said alert means, an exiting condition being at least one of an opened 4 door, an unbuckled seat belt, and a terminated ignition; and
(d) delivering said alert in response to sensing said exiting condition in step (c).

13. The method, according to claim 12, wherein said method includes the step of enabling said driver to record, by way of a microphone means coupled to said control means, at least one message to be delivered as said alert in step (d).

14. The method, according to claim 12, wherein said alert means includes an apparatus which is mounted onto a dashboard of said motor vehicle.

15. The method, according to claim 12, wherein said alert means is integrated into at least one predetermined portion of said motor vehicle.

16. A method of alerting a driver that is preparing to exit said motor vehicle to at least one of a presence of at least one of a child and an object and an action to be performed by said driver, said method comprising the steps of:
(a) sensing, by way of a vehicle computer, an exiting condition being at least one of an opened door, an unbuckled seat belt and a terminated ignition; and
(b) delivering an alert to said driver upon sensing said exiting condition in step (a).

17. The method, according to claim 16, wherein said alert includes at least one audio message which is delivered through at least one speaker means mounted within said motor vehicle.

18. The method, according to claim 17, wherein said at least one audio message is recorded by said driver through a microphone means coupled to said vehicle computer.

19. The method, according to claim 18, wherein said microphone means is operable by at least one control switch disposed within an entertainment system of said motor vehicle.
